(19) United States
(12) Patent Application Publication
(10) Pub. No.: US 2004/0249702 A1
(43) Pub. Date: Dec. 9, 2004

(54) Method of awarding electoral votes

(76) Inventor: Francis C. Clancey, Lynnfield, MA (US)

Correspondence Address: Richard C. Litman, LITMAN LAW OFFICES, LTD., P.O. Box 15035, Arlington, VA, 22215, US

(21) Appl. No.: 10/745,667

(22) Filed: Dec. 29, 2003

Related U.S. Application Data
(60) Provisional application No. 60/475,909, filed on Jun. 5, 2003.

(51) Int. Cl. G06F 17/60

(52) U.S. Cl. 705/12

(57) ABSTRACT

A method of awarding electoral votes to candidates based on their respective shares of the popular vote received. After an election is held, the total number of votes cast for each candidate is tabulated. Each candidate's percentage of the popular vote is then determined. This percentage is then used to determine each candidate's share of electoral votes in the jurisdiction in question. That is, if a candidate receives 42% of the popular vote, then the candidate will be awarded 42% of the state's electoral votes. Consequently, each person's vote will have added significance, as it will directly contribute towards their candidate's share of electoral votes.

### CROSS-REFERENCE TO RELATED APPLICATION

This application claims the benefit of U.S. Provisional Patent Application Ser. No. 60/475,909, filed Jun. 5, 2003.

### BACKGROUND OF THE INVENTION

1. Field of the Invention

The present invention relates to a method of conducting a political election. More particularly, the invention is a method of awarding electoral votes in a political election.

2. Description of the Related Art

The democratic principle of “one person, one vote” has long been a benchmark that is strived for, but often not achieved. For example, under our presidential electoral system, a candidate who receives the largest percentage of popular votes in a state generally receives all of that state's electoral votes. As a result, the segment of the population that voted for the less popular candidate(s) is effectively ignored. That is, since the winning candidate receives all of the electoral votes, all votes cast for the losing candidate(s) have no effect on the electoral process. This has lead to desperate struggles by presidential candidates to win the states with the most electoral votes, knowing full well that 11 such states often decide the outcome of an election. Moreover, once the “magic number” of electoral votes is achieved (i.e. 270), voting results in the remaining states become a moot point. Consequently, large numbers of votes have no effect on the outcome of an election. In addition, election results are challenged in court when the popular vote for each candidate is too close to call, because “the winner takes all” and the loser, despite having nearly the same number of votes, gets nothing. As a result of these and other types of problems, a variety of electoral systems and methods are reflected in the prior art.

U.S. Patent Application Publication No. 2002/0152379 A1, published on Oct., 17, 2002 by Gefwert et al., describes a voting method and device wherein voting takes place at a terminal. The voter's eligibility to vote is first verified by the terminal. The voter then selects a candidate, which generates an encrypted code corresponding to that candidate. This code is then transmitted to an election data system where it is decrypted and the vote contained therein is credited to the candidate.

U.S. Patent Application Publication No. 2002/0169756 A1, published on Nov. 14, 2002 by Biddulph, describes a voting system and method, which utilizes a computer to authenticate, poll and store user responses to a questionnaire, such as a ballot. Responses are recorded securely and anonymously, and a user may check his responses by accessing a response database.

U.S. Patent Application Publication No. 2002/0066780 A1, published on Jun. 6, 2002 by Balolia, describes a voting system comprising a kiosk system, a ballot form and a tabulation form. The kiosk system includes an output device, an input device, a tabulation system, a memory device, and a printer. A voter enters choices in the kiosk, which stores the data in memory and tabulates it. A printer then prints the voter's selections on the ballot form issued to the voter, and prints tabulation data on the tabulation form.

U.S. Patent Application Publication No. 2002/0072962 A1, published on Jun. 13, 2002 by Weiss, describes a method for secure, electronic, distributed voting using existing automated teller machines (ATMs). Each voter is issued an access card and a personal identification number (PIN) to be entered into the ATM machine. The ATM machine reads the access card and displays voting information. Users are then able to use ATM functions to cast their votes, which are tallied by the ATM.

U.S. Patent Application Publication No. 2002/0074399 A1, published on Jun. 20, 2002 by Hall et al., describes a voting method and system wherein a voter identification card is issued to a voter for use at a polling station. The card has an optical code including voter identification information, which is read at the polling station before the voter is allowed to vote. A handheld wireless device is then used to enter voting selections and a receipt showing the selections are printed. The voting selections for all voters are transmitted to a host computer for tallying.

World Intellectual Property Organization Patent Application Publication No. WO 02/077930 A1, granted to Jimenez on Mar. 10, 2002, describes an electronic ballot box that is used to scan votes as they are inserted in the ballot box. A beam of light scans a voter's selections on a ballot, even where the ballot is enclosed in an envelope. The box is also capable of tabulating the votes for each candidate and storing them in an electoral database.

Http://knesset.gov.il/description/Eng/eng_mimshal_beh.htm outlines the electoral system based in Israel, which is based on nation-wide proportional representation and the number of seats which every list receives in the Knesset (Israel's House of Representatives). In other words, the number of seats that each list receives in the Knesset is proportional to the number of votes it receives.

Although each of these publications and Web sites outline novel and unobvious inventions, what is really needed is an electoral method that treats all votes as being equally important without consideration to the importance of one state over another. Such an electoral method, particularly in light of the last presidential election, would be well-received in this country by voters and lawmakers alike.

None of the above inventions and patents, taken either singly or in combination, is seen to describe the instant invention as claimed. Thus a method of apportioning electoral votes based on the percentage of popular vote attained, solving the aforementioned problems is desired.

### SUMMARY OF THE INVENTION

The invention is a method for electing candidates to political office by apportioning a percentage of electoral votes to a candidate that corresponds to the percentage of the popular vote attained by that candidate. Under the current system, the candidate with the largest percentage of the popular vote is awarded all of the state's electoral votes, while the remaining candidate(s) get no electoral votes. In effect, all votes for the losing candidate(s) are rendered valueless, as the winner takes all of the electoral votes, and votes cast for the loser(s) are of no benefit to those candidates. The method of apportioning electoral votes described herein would remedy this situation by awarding each candidate a share of electoral votes corresponding to his or her share of the popular vote.

Accordingly, it is a principal object of the invention to apportion electoral votes in direct proportion to the percentage of popular votes received by a candidate in the jurisdiction in question.

It is another object of the invention to eliminate the “winner takes all” policy currently in effect in presidential elections wherein the candidate who wins the most popular votes in a state is awarded all of the state's electoral votes.

It is a further object of the invention to create an electoral system in which every vote cast for a candidate contributes to that candidate's share of electoral votes received.

It is a further object of the invention to reduce litigation respecting closely contested elections in one or more jurisdictions, wherein the electoral votes awarded to a candidate in a state are incorporated with the electoral votes the same candidate receives from the remaining forty-nine (49) states.

Still another object of the invention is to reduce the incidence of voter fraud during an election.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a flow chart depicting the process of apportioning electoral votes to a candidate in direct proportion to the candidate's share of the popular vote received.

FIG. 2 is an illustration of an electoral map of the United States indicating the electoral votes for each state during the last presidential election.

Similar reference characters denote corresponding features consistently throughout the attached drawings.

### DETAILED DESCRIPTION OF THE PREFERRED EMBODIMENT

The present invention is a method of awarding electoral votes 10 for electing candidates to political office. The method of awarding electoral votes 10 described below is best utilized in any jurisdiction in which a number of delegates are appointed or elected, whose responsibility it is to cast votes for candidate(s) for political office, and whose selection of candidate is governed in some way by the candidate's performance in a popular election. The preferred embodiment of the method of awarding electoral votes 10 is most aptly illustrated in the context of the 2000 United States Presidential Election, however, the invention may assume alternative embodiments for use in any type of election. It should therefore be understood, that the present disclosure is an exemplification of the principles of the method of awarding electoral votes 10 and does not limit the invention to the illustrated embodiments.

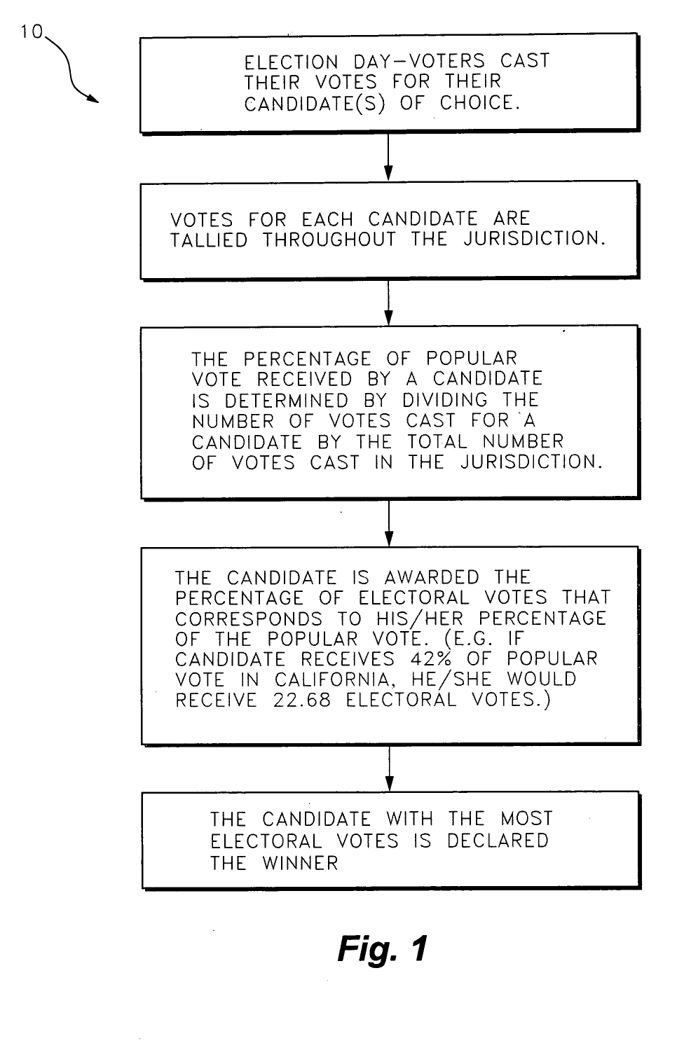

The method of awarding electoral votes 10 for political candidates provides that each candidate running for office will receive the percentage of electoral votes corresponding to the percentage of the popular vote each candidate receives. As is shown in FIG. 1, a flow chart depicting the electoral process 10 shows how the invention would be implemented. A method of awarding electoral votes 10 to candidates in an election, comprises voters casting their votes for their candidate of choice, tallying the votes for each candidate throughout a jurisdiction, determining the percentage of popular vote received by a candidate by dividing the number of votes cast for the candidate by the total number of votes cast in the jurisdiction, awarding the candidate the percentage of electoral votes that correspond to their percentage of the popular vote and declaring the candidate with the most electoral votes the winner.

In the context of the 2000 U.S. Presidential Election, candidates will receive a certain percentage of the popular vote in each of the fifty states. Each candidate's percentage of the popular vote will then be converted into electoral votes by multiplying the percentage of popular vote received by the total number of electoral votes possessed by the state in question. This process is repeated for every state.

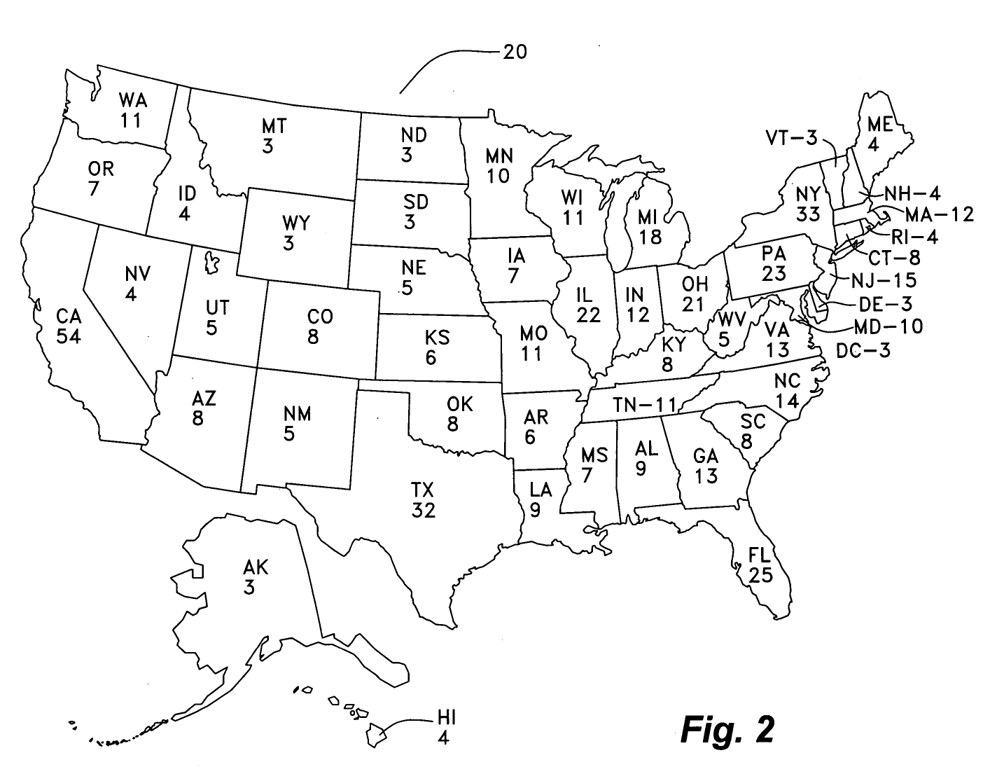

FIG. 2 illustrates an electoral map of the United States 20, which indicates the number of electoral votes possessed by each state for purposes of the 2000 U.S. Presidential Election. For example, in the last election Vice President Gore received fifty four percent (54%) of all votes cast in the state of California. Under the method herein described this percentage would be converted to Vice-President Gore's fair share of California's fifty-four electoral votes, which would be 29.16 electoral votes (54×0.54). Then Governor, George W. Bush, received forty-two (42%) of all votes cast. His share of electoral votes would therefore have been 22.68 electoral votes (54×0.42). Candidate Ralph Nader received four percent (4%) of the popular vote and his share of electoral votes would have been 2.16. When added together, the electoral votes apportioned to each candidate equal the total number of electoral votes assigned to the state:

| | |
|---|---|
| A. Gore | 29.16 |
| G. Bush | 22.68 |
| R. Nader | 2.16 |
| Total | 54.00 |

The four remaining candidates, (Buchanan, Browne, Phillips and Hagelin) failed to win enough votes to qualify for a percentage of California's electoral votes. Had this method been implemented in the last presidential election, the results could be represented as follows:

| | State's | | | | | | | |
|---|---|---|---|---|---|---|---|---|
| | Electoral | | | | | | | |
| | Votes | Bush | Gore | Nader | Buchanan | Browne | Phillips | Hagelin |
| Total | | | | | | | | |
| Votes Cast | | | | | | | | |
| By State | | | | | | | | |
| California | 54 | 42% | 54% | 0.04% | 0.0% | 0.0% | 0.0% | 0.0% |
| 10,679,577 | | 22.68 | 29.16 | 2.16 | 0 | 0 | 0 | 0 |
| Illinois | 22 | 43% | 55% | 0.02% | 0.0% | 0.0% | 0.0% | 0.0% |
| 4,741,748 | | 9.46 | 12.10 | 0.44 | 0 | 0 | 0 | 0 |

Voting statistics from the remaining 48 states would have yielded the following final results:

| | | | | | | | | |
|---|---|---|---|---|---|---|---|---|
| Total of | | | | | | | | |
| all 50 | | | | | | | | |
| States. | | | | | | | | |
| 103,715,797 | 537.96 | 260.29 | 258.92 | 14.95 | 1.98 | 1.68 | 0.14 | 0.0 |

There is a discrepancy of 0.04% due to voters in the state of Nevada casting a total of 608,899 votes, of which 3,315 voters did not vote for any of the seven candidates. Note that this is 0.01% or 0.04 of the total ballots cast and that the state of Nevada has an award of 4 electoral votes.

In this way, every vote cast contributes to the selected candidate's total electoral votes. This method stands in stark contrast to the present method in which millions of votes have no effect on electoral votes (e.g. in California, the 4,437,557 votes for Bush produced no electoral votes for him).

Furthermore, no constitutional amendment would be necessary in order to implement this method. There is no constitutional requirement that all of a state's electoral votes be awarded to the candidate with the greatest share of the popular vote. In fact, two states (Maine and Nebraska) award only two electoral votes to the winning candidate, with the rest of the electoral votes distributed according to the winner of each congressional district in the state. The Constitution requires only that each state appoint a number of electors equaling the total number of congressmen (senators and representatives) from that state, and that such electors vote for the President and the Vice-President. Accordingly, the states can decide for themselves whether to implement the method herein discussed.

It is to be understood that the present invention is not limited to the embodiment described above, but encompasses any and all embodiments within the scope of the following claims.

I claim:

1. A method of awarding electoral votes to candidates in an election, with a percentage of a popular vote for each candidate, a number of votes cast for each candidate, a total number of votes cast, a candidate with a highest percentage of the electoral vote and a winner of the election, comprises:
voters casting their votes for the candidate(s) of their choice;
tallying the votes for each candidate throughout a jurisdiction;
determining the percentage of the popular vote received by each candidate by dividing the number of votes cast for the candidate by the total number of votes cast in the jurisdiction;
awarding each candidate the percentage of electoral votes that correspond to their percentage of the popular vote; and
declaring the candidate with the most electoral votes a winner.

2. The method of awarding electoral votes according to claim 1, further comprising the step of being best utilized in any jurisdiction in which a number of electors are appointed and elected whose responsibility it is to cast votes for the candidates to political office.

3. The method of awarding electoral votes according to claim 1, further comprising the step of providing that each candidate will receive the percentage of electoral votes corresponding to the percentage of the popular vote each candidate receives.

4. The method of awarding electoral votes according to claim 3, further comprising the step of multiplying the percentage of popular vote received by each candidate by the total number of electoral votes for each state.

5. The method of awarding electoral votes according to claim 1, further comprising the step of having every vote cast contributing to the selected candidate's total electoral votes.
